(19) United States
(12) Patent Application Publication
(10) Pub. No.: US 2015/0001084 A1
(43) Pub. Date: Jan. 1, 2015

(54) TWO DIMENSIONAL NANOFLUIDIC CCD ARRAYS FOR MANIPULATION OF CHARGED MOLECULES IN SOLUTION

(71) Applicant: Agilent Technologies, Inc., Loveland, CO (US)

(72) Inventors: Brian Jon Peter, Santa Clara, CA (US); John T. Mannion, Loveland, CO (US); Alice Yamada, Loveland, CO (US)

(73) Assignee: AGILENT TECHNOLOGIES, INC., Loveland, CO (US)

(21) Appl. No.: 14/365,637

(22) PCT Filed: Dec. 20, 2012
(86) PCT No.: PCT/US2012/071004

§ 371 Date: Jun. 15, 2014

(30) Foreign Application Priority Data
Dec. 28, 2011 (US) 61580952

(51) Int. Cl. G01N 27/447

(52) U.S. Cl. CPC G01N 27/44791
USPC 204/601

(57) ABSTRACT

The invention generally relates to methods and apparatus for manipulation of charged molecules in solution. More particularly, the invention provides nanofluidic CCD arrays that are capable of manipulate one or a group of molecules on an individual bases such that they undergo controlled physical and/or chemical movements and/or transformations.

### PRIORITY CLAIMS AND RELATED PATENT APPLICATIONS

This application is the national phase of PCT/US12/71004, filed on Dec. 20, 2012, which claims the benefit of priority from U.S. Provisional Application Ser. No. 61/580,952, filed on Dec. 28, 2011, the entire content of each of which is incorporated herein by reference in its entirety.

### FIELD OF THE INVENTION

The invention generally relates to methods and apparatus for manipulation of charged molecules in solution. More particularly, the invention provides nanofluidic CCD arrays, and related methods, that are capable of manipulate one, or a group of molecules or nanoparticle(s) on an individual bases such that they undergo controlled physical and/or chemical movements and/or transformations.

### BACKGROUND OF THE INVENTION

Currently, microfluidic devices strive for the control of small numbers of molecules, or ideally single molecules, throughout various microfluidic compartments and channels with micrometer or submicrometer precision. To date, the two most widely used forms of actuation in microfluidic devices are electrokinetic (electrophoresis and electro-osmosis) and pressure driven flow.

In electrokinetic actuation, an electrical connection is made with the microfluidic channels through the use of electrodes in fluidic reservoirs located at the ends of the microfluidic channels. A voltage difference between electrodes results in electrokinetic forces in the device. However, if an array of channels, or any network of channels, is present, it is extremely difficult to establish an electric field in one channel without affecting other channels. Not only is it currently impractical to electrically isolate single channels, if more than one molecule is present within a single channel, the molecules may not be controlled or manipulated independently.

Pressure driven flow may be considered a blunt method for moving molecules within a network of microfluidic channels. Typically, pressure fittings are fixed at interfaces between the microfluidic channel network and the microscopic world, and pressure is applied at the channel endpoints. In its most complex form to date, a microfluidic pressure based device is made from an elastomeric material, and microfluidic pumps and valves are integrated at various points within the fluidic network. In these devices, channels may be isolated from one another; however, control over fluidic elements is limited in resolution by the minimum size and density of the pumps and valves. Bulky connections to macroscale pumps and valves must be made, further increasing the complexity and size of the overall device, and further limiting the density of elastomeric microfluidic pumps and valves.

Similarly, DNA molecules in conventional nanofluidic devices are moved in bulk via electrophoresis, electroosmotic flow, capillary action, or pressure-driven flow. All molecules have an equal chance of interacting with a specific region of the device. For example, a typical nanofluidic device may contain a restriction digestion activity in one region, but all molecules have an equal probability of being digested. Thus, with existing devices it is not difficult to select one or a few molecules and divert them to a particular region of the device to undergo a preselected transformation (e.g., to a digestion zone), without the use of complicated pumps and/or valves.

Precise localization of biochemical activities in nanofluidic devices remains challenging. Nanofluidic fabrication methods often involve high temperatures, chemical etchings, vacuum, etc., and are often incompatible with maintaining biological activities of enzymes or nucleic acids integrated into the device. Furthermore, if enzymes are introduced to the device after fabrication, the bulk flow of the enzyme into the device may preclude localizing the enzyme to a specific area. Finally, even if the enzyme can be localized to a specific region of the device, the necessary bulk flow of analytes by pressure or electrophoretic flow may dislodge the enzyme rendering the biochemical transformation in effective or incomplete.

Thus, unmet needs remain for novel nanofluidic apparatus and methods that are capable of individualized movement and controlled manipulation of a molecule or group of molecules in solution environment, particularly for large biological molecules such as DNA molecules.

### SUMMARY OF THE INVENTION

The invention is based in part on the unexpected discovery of novel nanofluidic apparatus and methods that are capable of individualized movement and controlled manipulation of a molecule or group of molecules in solution environment. A key feature of the nanofluidic CCD array technology disclosed herein is that molecules or nanoparticles, in particular DNA and other large biomolecules, can be individually manipulated and moved to spatially distinctive parts (e.g., reaction stations) of the nanofluidic device, without the use of electrophoresis or pressure. For example, a nanofluidic CCD array can be constructed such that different regions of the array have different biochemical activities (e.g., a restriction enzyme to digest the DNA, or a polymerase to incorporate labeled nucleotides). An exceptional aspect of the present invention is that biomolecules such as DNA molecules can be readily moved between reaction stations by a combination of diffusion and nanofluidic charge coupling, rather than by bulk flow. These DNA molecules can be made to stay at a reaction station to under biophysical or biochemical transformations for preselected and controllable time periods. Thus, different DNA molecules in a single nanofluidic device can be addressed and treated individually, all without the use of valves.

In one aspect, the invention generally relates to an apparatus for manipulation of a molecule or group of molecules in a solution. The apparatus includes: (1) a nanofluidic cavity, a bottom of which is made of a dielectric layer, wherein the depth of the nanofluidic cavity is on the order of or less than the ionic screening length of the solution filling the nanofluidic cavity; (2) a plurality of electrodes arranged on a surface of the dielectric layer opposite a surface of the dielectric layer having the nanofluidic cavity, wherein a spacing between individual electrodes in the array of electrodes is not significantly greater than the ionic screening length of the solution filling the nanofluidic cavity; and (3) a plurality of vias individually connected to the individual electrodes for connection to an external electronic device.

In another aspect, the invention generally relates to an apparatus for manipulation of a molecule or group of molecules in a solution. The apparatus includes: (1) a nanofluidic cavity, wherein a depth of the nanofluidic cavity is on the order of or less than the ionic screening length of the solution filling the nanofluidic cavity; (2) an array of electrodes arranged on a surface the nanofluidic cavity, wherein a spacing between individual electrodes in the array of electrodes is not significantly greater than the ionic screening length of the solution filling the nanofluidic cavity; and (3) an array of vias individually connected to the individual electrodes in the array of electrodes for connecting the array of electrodes to an external electronic device. An applied voltage applied to the individual electrodes in the array is less than an overpotential required to transfer an electron from the metal electrode to any chemical species in solution.

### BRIEF DESCRIPTION OF DRAWINGS

FIG. 1 is a schematic of a basic element of an apparatus in accordance with one or more embodiments of the invention.

FIG. 2 is a schematic illustration of an apparatus in accordance with one or more embodiments of the invention.

FIG. 3 is a schematic illustration of an apparatus in accordance with one or more embodiments of the invention.

FIG. 4 is a schematic of illustration an apparatus in accordance with one or more embodiments of the invention.

FIGS. 5A-5D are schematic illustrations of one or more operations of an apparatus in accordance with one or more embodiments of the invention.

FIG. 6 is a schematic illustration of one or more operations of an apparatus in accordance with one or more embodiments of the invention.

FIG. 7 is a schematic illustration of one or more operations of an apparatus in accordance with one or more embodiments of the invention.

FIG. 8 is a schematic illustration of a method of manufacturing of an apparatus in accordance with one or more embodiments of the invention.

FIG. 9 is a schematic illustration of a method of manufacturing of an apparatus in accordance with one or more embodiments of the invention.

FIG. 10 is a schematic illustration of a method of manufacturing of an apparatus in accordance with one or more embodiments of the invention.

FIG. 11 is flowchart in accordance with one or more embodiments of the invention.

FIG. 12 is a schematic illustration of an apparatus in accordance with one or more embodiments of the invention.

FIG. 13 is a schematic illustration of an apparatus in accordance with one or more embodiments of the invention.

FIG. 14 is a schematic illustration of an apparatus in accordance with one or more embodiments of the invention.

FIGS. 15A-15C are schematic illustrations of electrode element in the nanofludic CCD array in accordance with one or more embodiments of the invention.

FIG. 16 is a schematic illustration of a two-dimensional nanofluidic CCD arrays invention with specific areas for bound enzymatic activities in accordance with one or more embodiments of the. (A) Top view of electrode pads (grey) with modified attachment squares (black). (B) Top view of electrode pads (grey) and modified attachment squares in a nanofluidic slit (3D view).

FIG. 17 is a schematic illustration of the top view of DNA molecules moving in nanofluidic CCD array in accordance with one or more embodiments of the invention.

FIG. 18 is a schematic illustration of the top view of a nanofluidic CCD array with more than one enzymatic activity bound in different regions in accordance with one or more embodiments of the invention.

### DETAILED DESCRIPTION OF THE INVENTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relate to an apparatus for the manipulation of a molecule, or group of molecules, or nanoparticle(s) in a solution. More specifically, embodiments of the invention relate to an apparatus for the independent actuation of single molecules or groups of molecules or nanoparticle(s) in a nanofluidic environment. Single molecule studies in nanofluidic environments are currently being explored; see for example, U.S. Patent Publication No. 20110227558, the contents of which are hereby incorporated by reference in its entirety for all purposes.

Additionally, embodiments of the invention relate to a method for the manipulation of a molecule, or group of molecules, or nanoparticle(s) in a solution. More particularly, embodiments of the invention provide nanofluidic CCD arrays-based methods that are capable of manipulating one or a group of molecules or nanoparticle(s) on an individual bases such that they undergo controlled physical and/or chemical movements and/or transformations.

Analogous to how a charge coupled device (CCD) array shuffles charges through an imaging chip, embodiments of the invention allow for the discrete movement of single molecules, or groups of molecules, dispersed in a solution within a cavity. For the purposes of this invention, a cavity refers to slit, channel, or similar space that contains the solution. A cavity may also refer to wide channel or chamber definable by a shallow depth in the vicinity of a buried gate electrode. In some embodiments, the cavity may be referred to as a nanocavity. Also, for the purposes of this invention, the term nanofluidic cavity refers to a fluid filled cavity with at least one dimension on the order of, or smaller than, one hundred nanometers. The phrase “on the order of” as used herein indicates that one quantity is of the same order of magnitude as another quantity. In this document, two quantities are of the same order of magnitude as long as the two quantities do not differ from one another by more than a factor of one hundred.

One or more embodiments of the invention include an array of independently addressable buried gate electrodes in close proximity to the cavity. The array of independently addressable buried electrodes may or may not be separated from the solution of molecules in the cavity by a dielectric. The depth of the cavity that contains the solution of molecule forces some or all of the molecules to reside within a distance to the electrodes that is on the order of or less than the ionic screening length of the solution.

Therefore, in one or more embodiments of the invention, a voltage applied to a single buried electrode may not be fully shielded by buffer ions in solution except at distances that are large compared with the depth of the channel. As such, the electrostatic potential through substantially the entire depth of the channel above the electrode pixel may be perturbed. Embodiments of the invention may enable discrete, independent, and programmable actuation of charged molecules, macromolecules, or packets of charged molecules in a nanofluidic environment. The motion of the molecules induced by the array of buried gate electrodes is distinct from traditional electrophoretic motion of charged species in microfluidic or nanofluidic environments because no electron transfer actually occurs at the electrode and solution interface. Thus, there may be no direct current flowing through the device.

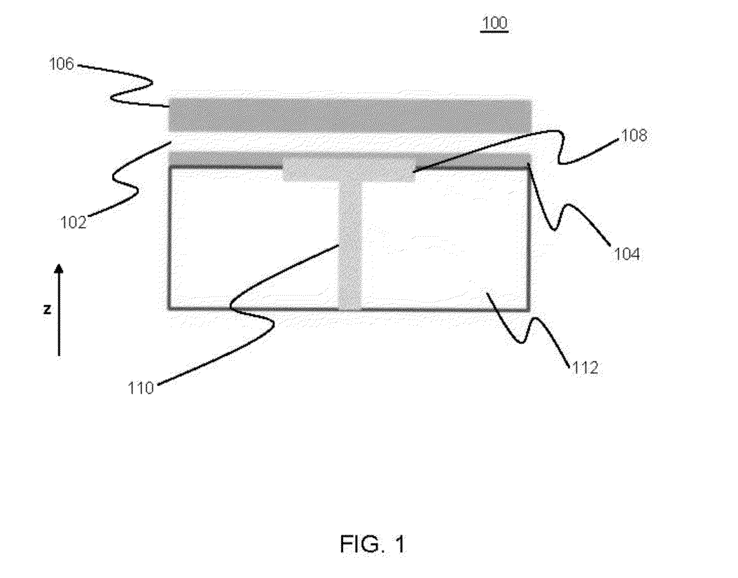

FIG. 1 is a schematic of a basic element of an apparatus in accordance with one or more embodiments of the invention. FIG. 1 is a basic element 100 that includes a cavity 102. The bottom of the cavity 102 may optionally consist of a dielectric layer 104. The top of the cavity 102 includes a ceiling material to define the cavity. For example, the ceiling material may be comprised of a dielectric 106. An electrode 108 may be arranged on the surface of the dielectric layer 104 opposite to the surface of the dielectric layer 104 of the cavity 102. A conductive via 110 is connected in the substrate 112 for connecting the electrode 108 to an external or on-chip electronic device, such as a power supply.

The substrate 112, dielectric layer 104, and ceiling 106 are electrically insulating. Examples of materials of the substrate 112 include, but are not limited to, silicon, or fused silica. Examples of the material of the dielectric layer 104 and ceiling 106 include, but are not limited to, silicon dioxide, silicon nitride, or aluminum oxide. The electrode 108 and conductive via 110 may be constructed of metal, polysilicon, or other conductive materials.

The depth of the cavity 102 in the z direction in FIG. 1, for example, may be on the order of 10 nm to 50 nm. The thickness in the z direction of the dielectric layer 104, for example, may be on the order of 10 nm to 15 nm. Therefore, the sum of the thickness of the dielectric layer 104 and the depth of the cavity 102, for example, may be no greater than 65 nm. The depth of the cavity 102 that contains the solution of molecules is designed to force the molecules to reside within a distance to the gate electrodes that is on the order of or less than the ionic screening length of the solution. Therefore, one of ordinary skill in the art would understand that the thickness of the dielectric layer 104 and the depth of the cavity 102 are not limited to the values given above. The ionic screening length of the solution may be determined by the ionic species and their concentrations. The solution, thickness of the dielectric layer 104, the depth of the cavity 102, and voltage applied to the electrode 108 may all be coordinated to achieve a specific desired result.

In one or more embodiments of the invention, the dielectric layer 104 is of sufficient thickness and quality such that electrical breakdown does not occur within the range of voltages applied to the electrode 108 through the conducting via 110. In one or more embodiments of the invention the dielectric layer 104 is made of a material that prevents any electrochemical reactions from occurring at the electrode 108.

In one or more embodiments of the invention, the dielectric layer 104 may be omitted. In these embodiments, the applied potential is controlled to compensate for the lack of the dielectric layer. In these embodiments, the bare electrode may cause current to flow into the solution containing the molecule, or groups of molecules, and may allow molecules to be moved by electrophoresis, as is traditionally done in microfluidic and nanofluidic devices, if the applied voltage was too high. However, one of ordinary skill in the art would recognize, in view of the present disclosure, that molecule manipulation in the nanofluidic CCD mode may be achieved without the dielectric layer 104, if the voltage applied to the electrodes in the array is less than an overpotential required to transfer an electron from the electrode to any chemical species in the solution.

The cavity 102 may be deep enough to allow the molecules of interest to enter, but shallow enough such that the perturbation caused by the potential on the electrode 108 on the fluid is not screened by mobile charge carriers over substantially the entire depth of the cavity 102, or at least over some noticeable fraction of the cavity. In other words, the depth of the cavity may be on the order of, or less than, the ionic screening length of the solution. Further, the shallower the cavity is in relation to the ionic screening length, the stronger the electric coupling between the buried electrode and the molecules of interest may be throughout the depth of the cavity. Additionally, as mentioned previously, the screening length may be an adjustable parameter because the screening length depends on the ionic strength of the buffer solution.

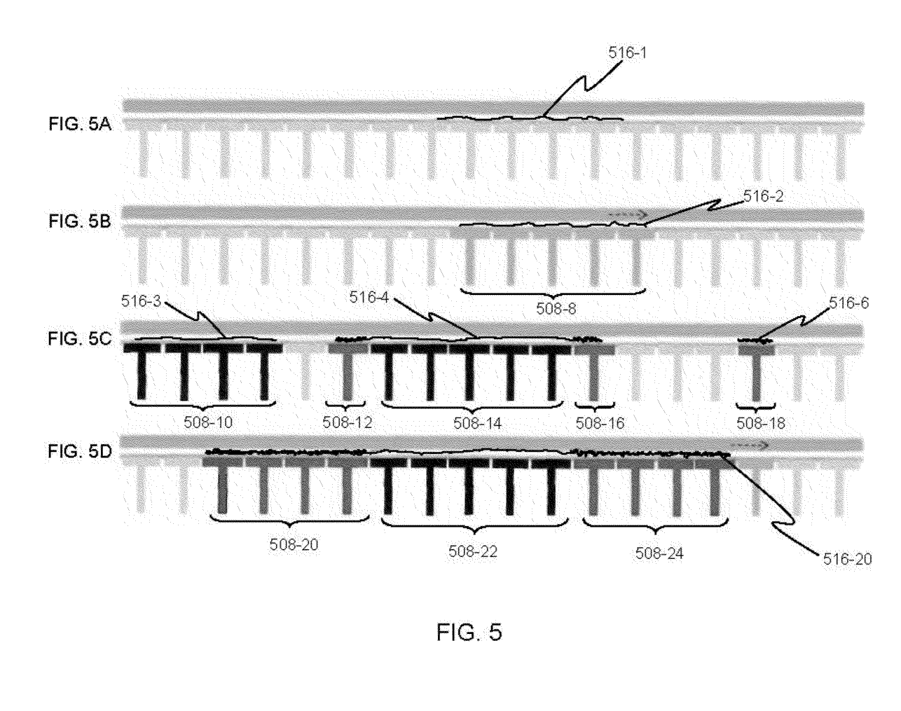

It should furthermore be noted that in the case where the ionic screening length is only a fraction of the channel depth (5-10% for example) it may still be possible to move molecules across the array in the CCD mode of operation. For example, if a long DNA molecule spanned a part of the channel over a number of buried electrodes, but the channel depth was ten times the ionic screening length the device may still be used in the CCD mode of operation. Under these conditions, if a large negative potential is applied to one of the electrodes, the segment of DNA above the electrode may be excluded from the bottom fraction of the channel (the bottom tenth of the channel volume). The large negative potential may effectively cause the molecule to be more tightly confined in the vertical direction. Such confinement may result in a horizontal stretching of the molecule, as shown by molecule 516-3 illustrated in FIG. 5C.

Non-uniform confinement along the length of the molecule may result in entropic forces in the horizontal plane of the nanocavity, which may be used to move the molecule across the array. Such confinement-induced entropic forces, acting on DNA molecules in nanofluidic environments, are well understood in the field of nanofluidics. (See, e.g., “Conformational Analysis of Single DNA Molecules Under going Entropically Induced Motion in Nanochannels” by Mannion, et. al. 2006 Biophysical Journal Vol. 90, p4538). An electrostatic force may be used to push the molecule vertically upwards in the cavity, pressing the molecule partly against the ceiling. The vertical squeezing may result in an entropic force that acts in the horizontal direction, driving the molecule out of the space above the negative electrode, toward the space above an adjacent electrode. Embodiments of the invention include one and two-dimensional arrays of the basic component 100 shown in FIG. 1. It is worthy to note that a small number of isolated basic components 100 may be used as gates to control the flow of molecules in a cavity.

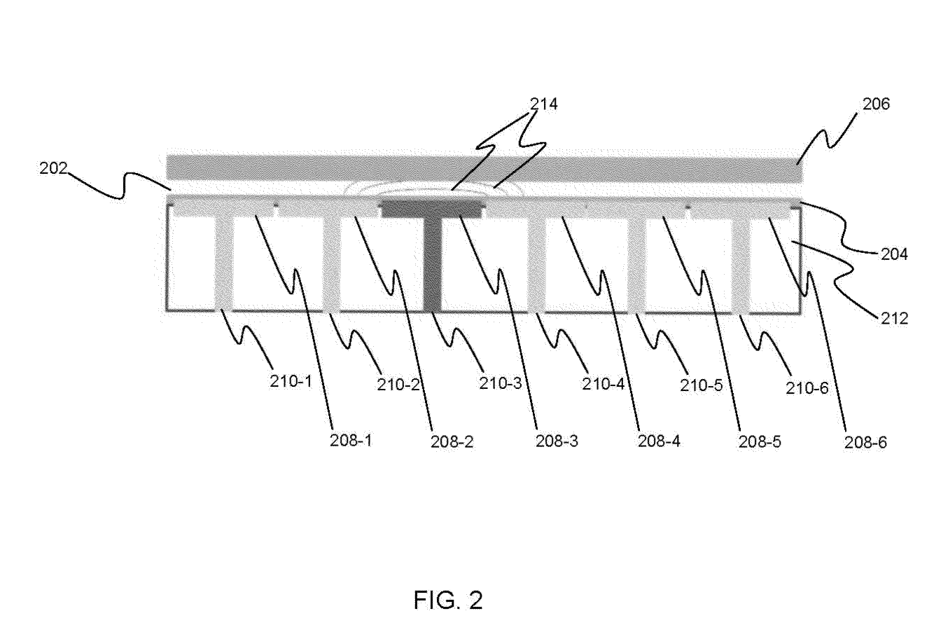

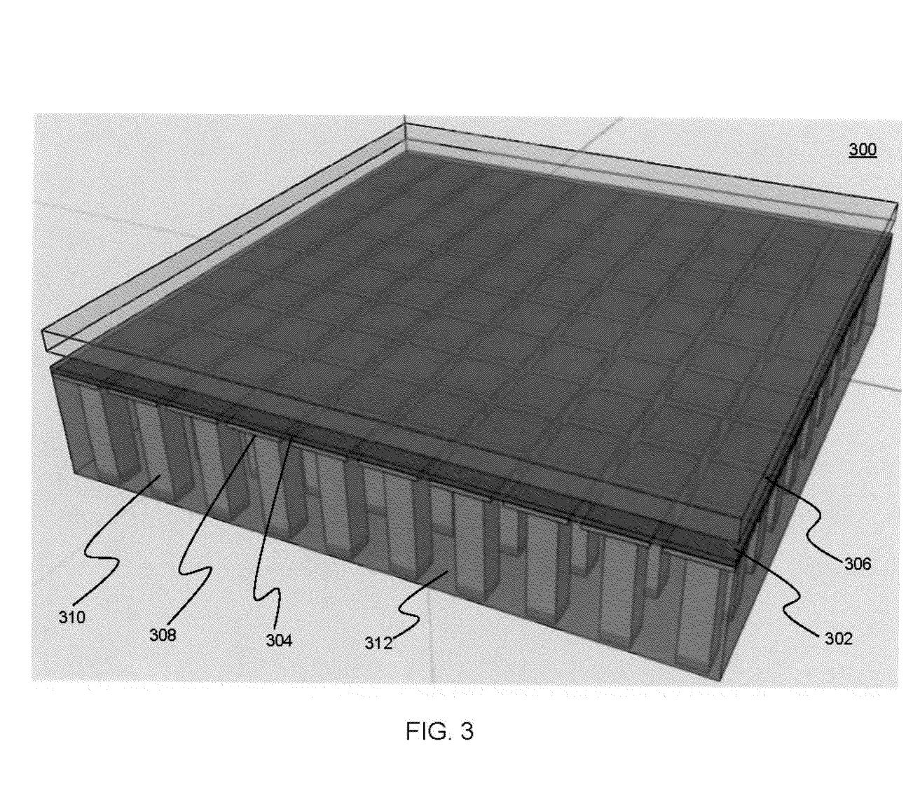

FIG. 2 is a schematic of a one-dimensional array of the basic components 100 shown in FIG. 1 in accordance with one or more embodiments of the invention. The array includes a cavity, or channel, 202 with a series of electrodes 208-1 . . . 208-6 coated by a dielectric layer 204. Each of the electrodes 208-1 . . . 208-6 is connected to conductive vias 210-1 . . . 210-6 in the substrate 212 for connecting the electrodes 208-1 . . . 208-6 to one or more external or on-chip electronic devices (not shown). In one or more embodiments of the invention, the surface of the dielectric 204 on the electrodes 208-1 . . . 208-6 may be coplanar with the surface of the dielectric 204 covering the areas between electrodes 208-1 . . . 208-6. The coplanar surface may further prevent molecules from preferentially residing in the areas between electrodes 208-1 . . . 208-6. The array shown in FIG. 2 is a portion of an isolated row of gates running along the axis of a nanochannel type cavity. The array shown in FIG. 2 may also be part of a larger two-dimensional array, as will be shown in reference to FIG. 3.

In one or more embodiments of the invention, each of the electrodes 208-1 . . . 208-6 may be independently addressable through the conductive vias 210-1 . . . 210-6 by the external or on-chip electronics. Alternatively, two or more of the electrodes 208-1 . . . 208-6 may be addressable as a group, depending on the relative size of the molecule, or molecules, and the electrodes 208-1 . . . 208-6.

For example, in FIG. 2, electrodes 208-1, 208-2, 208-4, 208-5, and 208-6 are depicted as electrically floating, while the voltage on electrode 208-3 is set by an external power supply through the via 210-3. The voltage on electrode 208-3 creates an electric field shown by the equipotential lines 214 which penetrate the dielectric 204. The electric field shown by the equipotential lines 214 is used to manipulate the molecule or molecules, in the cavity 202. Electron transfer does not occur at the interface of the dielectric 204; therefore, no electrochemical reactions may take place, and a steady state, direct current may not established in the electrolyte. In addition, the electric field shown by the equipotential lines 214 may only extend a short distance along the length of the cavity 202. Preferably, the electric field shown by the equipotential lines 214 barely penetrates the space above the adjacent electrodes 208-2 and 208-4. In order to move charged molecules along the cavity, the voltages applied to the vias 210-1 . . . 210-6 may be toggled, similarly to that of traditional CCD arrays. This toggling method may also be considered analogous to the action of a peristaltic pump, for example.

In one or more embodiments of the invention, the area of the electrode may be designed relative to the size of the molecule or molecules of interest. If the molecules of interest are smaller than the area covered by the electrode, then the space between adjacent electrodes should be approximately equal to or less than the ionic screening length, and consequently the depth of the nanochannel. Therefore, the molecule may not become trapped in a “dead zones” in between the electrodes. If the molecules of interest cover a hydrodynamic area larger than the area of the electrodes, then the array pitch may be less than or equal to the hydrodynamic radius of the molecules. In one or more embodiments of the invention, both of the previous conditions may be met. As the size and spacing between adjacent electrodes decrease, the spatial resolution of the apparatus may be increased.

FIG. 3 is a three dimensional perspective of a two dimensional array of the basic components 100 shown in FIG. 1 in accordance with one or more embodiments of the invention. The two dimensional array apparatus 300 utilizes a nanochamber cavity 302. Similar to the apparatus shown in FIG. 2, the substrate 312 includes a two dimensional array of vias 310 with electrodes 308. The cavity 302 is positioned between a thin dielectric layer 304 and a ceiling 306. As shown in FIG. 3, the two-dimensional apparatus 300 has a uniform ordered array of electrodes 308. However, embodiments are not limited as such. For example, the relative size and spacing of the electrodes 308 need not be uniform. Depending on the specific goals and applications of the device, the electrodes 308 may be designed with different sizes. Further, the cavity 302 may include chambers, channels, and subchannels depending on the specific application. In the embodiments demonstrated by FIG. 3, not only the location, but also the shape of a molecule may be controlled by adjusting electrode voltages on the electrodes 308.

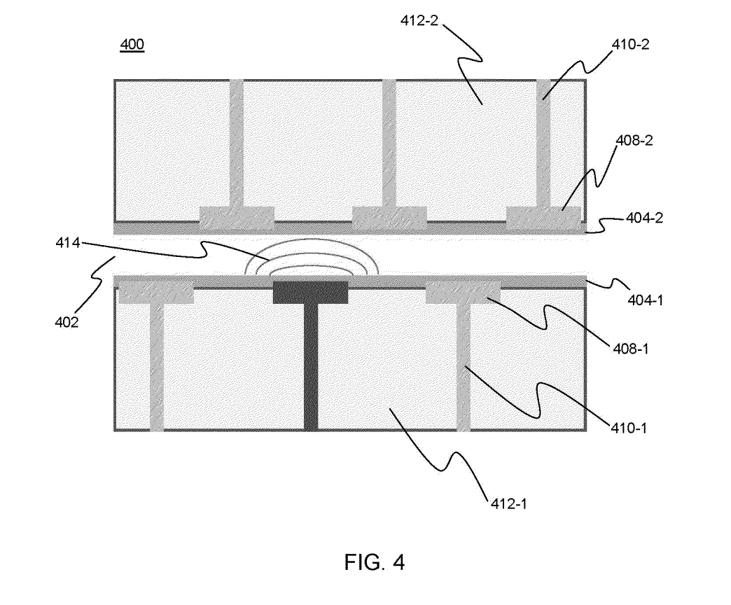

FIG. 4. is a schematic of an apparatus in accordance with one or more embodiments of the invention. FIG. 4 includes an apparatus 400 with electrodes 408-1 on one side of a (channel or slit) cavity 402 and electrodes 408-2 on an opposite side of the cavity 402. One of ordinary skill would recognize that the electrodes need not necessarily be on opposite sides of the cavity 402, but may also be located on adjacent sides of cavity or a combination of both configurations. As shown in FIG. 4 the electrodes may be staggered. As described above, the forces that may be exerted on a molecule in a cavity 402 by the equipotential lines 414 generated by a voltage applied through a vias 410-1, 410-2 are a function of the applied voltage, the depth of the cavity 402, the thickness of the thin dielectric layers 404-1, 404-2, and the ionic strength of the solution. By arranging electrodes 408-1, 408-2 on multiple walls (e.g., top and bottom, or both side walls) of the cavity 402, the above influences on the force of a molecule may be modified. For example, an increase in the number of electrodes 408-1, 408-2 may allow for the depth of the cavity 402 to be increased, or the thickness of the dielectric layers 404-1, 404-2 may be increased. Alternatively, the apparatus 400 may be capable of manipulating molecules in a stronger ionic solution, or may require less applied voltage to operate.

FIGS. 5A-5D are schematics demonstrating some examples of operations that may be performed by one or more embodiments of the invention. In FIG. 5A, a molecule 516-1, DNA for example, is located within the cavity with the applied voltages to the electrodes 508 being off. The molecule 516-1 is at rest and elongated to its equilibrium extension length in the cavity. FIG. 5B demonstrates the molecule being moved to the right relative to the molecule position shown in FIG. 5A in accordance with one or more embodiments of the invention. The molecule 516-1 may be moved to right by sweeping a positive voltage state across the electrodes 508. For example, as shown in FIG. 5B, a slightly positive voltage is applied to electrodes 508-8 in order to shift the position of the molecule 516-2 one electrode, or pixel, to the right relative to the position of the molecule 516-1 shown in FIG. 5A.

FIG. 5C shows a molecule being mildly hyper-extended in accordance with one or more embodiments of the invention. In FIG. 5C, the molecule 516-3 may be mildly hyper-extended by squeezing the molecule 516-3 with a negative voltage applied to electrodes 508-10. In one or more embodiments of the invention, a molecule 516-4 may be more hyper-extended by pulling at the ends of the molecule 516-4 with positive voltage applied to electrodes 508-12 and 508-16 along with squeezing the molecule 516-4 in the middle by applying a negative voltage to electrodes 508-14. Also shown in FIG. 5C is a molecule 516-6 which has been compressed above a single electrode 508-18 by applying a strong positive voltage to the single electrode 508-18 in accordance with one or more embodiments of the invention.

FIG. 5D shows a large molecule both compressed and hyper-extended in accordance with one or more embodiments of the invention. A long molecule 508-20 may be compressed along most of the molecule's 508-20 length by the application of a positive voltage to the electrodes 508-20 and 508-24. A selected portion of the molecule 508-20 may be hyper-extended by the application of a negative voltage to the electrodes 508-22. In one or more embodiments of the invention, the positive charge on one of the electrodes in the group of the electrodes 508-20 may be subtracted from the left side and another positively charged electrode may be added to the right of the group of electrodes 508-24. As a result, the entire molecule 516-20 may be shifted to the right. Further, in one or more embodiments, the molecule 516-20 may be pulled through the region of the cavity above the group of electrodes 508-22, so that portions of the molecule 516-20 may be examined in detail, while keeping track of the molecule's 516-20 position relative to the endpoints.

In one or more embodiments of the invention, molecules are moved during the brief transition period after the electrode voltages have been changed, and before a steady state rearrangement of mobile charge carriers is reached in solution. For example, movement of the molecules is achieved by the charging and discharging closely spaced fluidic electrodes. Because rearrangement happens quickly, to move the molecule over an appreciable distance of the array, the voltages on the array electrodes may be continually switched, to shuffle the charges from one adjacent electrode to the next. This is a distinction in the device operation as compared with the standard “electrode in reservoir” apparatus and, advantageously, may open new realms of possibilities for nanofluidic sample handling.

In one or more embodiments of the invention, certain analyte molecules may respond to the change in voltage of the buried electrode over a timescale longer than that required for the majority of electrolyte ions to respond. For example, a large DNA molecule may initially occupy the space above multiple neutral electrodes, and one electrode potential may be suddenly set to a high negative voltage. The DNA molecule may eventually shift its position so that it resides above the neutral electrode. However, the speed at which the molecule shifts position depends, in part, on the relationship between the depth of the channel and the ionic screening length. If the ionic screening length is longer that the depth of the nanocavity, the DNA molecule may experience a strong repulsive force in the vertical direction, and may not only move upwards in the cavity, away from the negative electrode, but may also be excluded from the entire volume above the negative electrode as a result of the electric fields present in that space. If the ionic screening length is relatively short however, for example a tenth of the channel depth, the DNA molecule may only be excluded from the bottom portion of the volume of fluid above the negative electrode (the bottom tenth of that volume). The DNA may still reside in the top 90% of that volume, without experiencing a strong electrical repulsion. However, this slight squeezing in the vertical direction by electric fields may lead to a confinement-induced entropic force acting in the horizontal direction. Thus, even after the electrolyte ions rearrange in response to the negative applied voltage, the confinement-induced entropic forces may continue to act on a macromolecule such as a long DNA molecule. In both cases, the DNA molecule may be moved long distances over the electrode array through a sequence of toggled voltages that shuffle the molecule from electrode to electrode. However, in the second case, the electrode voltages may need to be toggled at a slower clock speed, such that the DNA molecule may not fall behind pace of the changing electrode voltages. Similarly, if a charged molecule being moved has a low electrophoretic mobility, the molecule may move slower than the amount of time required to set new voltages on electrodes. Thus, a sufficiently long delay period may be provided during the toggling of the voltages.

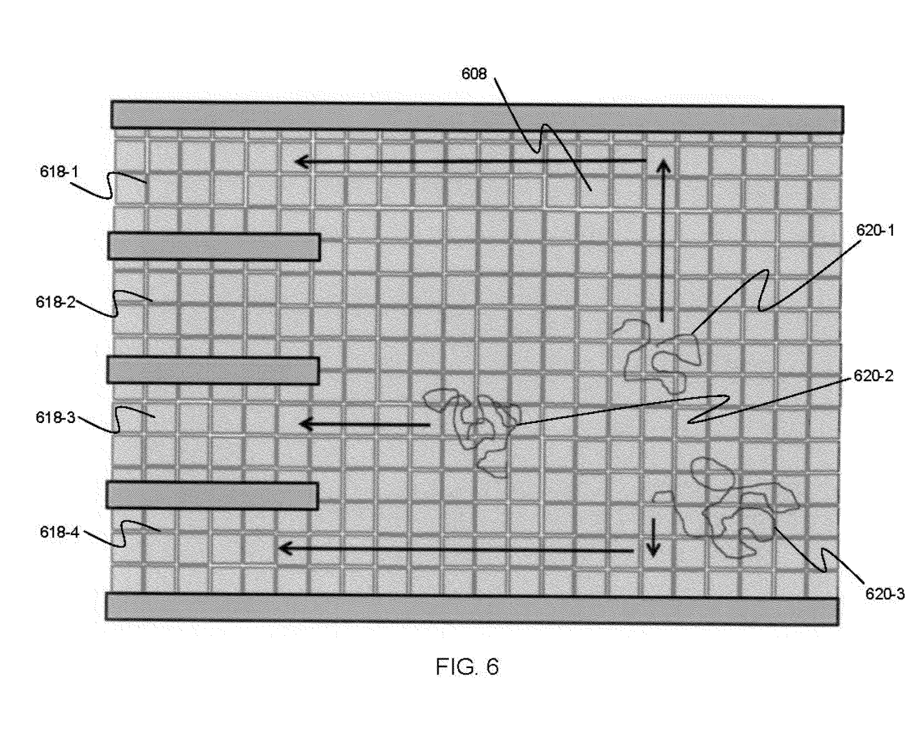

In one or more embodiments of the invention, a network of nanofluidic channels may allow for molecules to be sorted in a serial fashion without being dumped into a macrofluidic reservoir, where they may be lost in the large fluidic volume, or where they may directly contact the electrode surface. FIG. 6 is a schematic of a two dimensional array of electrodes 608 where the main cavity has been divided into channels, or chambers 618-1 . . . 618-4. The chambers 618-1 . . . 618-4 may be fabricated into the device using additional dielectric materials. In addition, the chambers 618-1 . . . 618-4 may be virtual by the application of voltages to the electrodes. For example, by applying specific voltages to the electrodes a charged “virtual” wall and, thus, the chambers 618-1 . . . 618-4 may be formed. Walls, channels, and chambers formed by the application of voltages to the array of electrodes may provide the advantage of manufacturing a single device for multiple purposes. Furthermore, because the walls may be moved or relocated by the independently addressable electrodes 608, additional versatility and capabilities of the apparatus are achieved.

For example, a collection of chromosome fragments 620-1 . . . 620-3 may be loaded into the cavity area, either from above (e.g., through access in the ceiling) or may be supplied from a microchannel (not shown) on the right side of FIG. 6. The group of chromosome fragments 620-1 . . . 620-3 may then be teased apart and each chromosome fragment could be shuffled into its own channel. As shown by the arrows in FIG. 6, the chromosome fragment 620-1 may be moved into the chamber (or channel) 618-1. Similarly, the chromosome fragment 620-2 and chromosome fragment 620-3 may be moved into the chamber 618-3 and chamber 618-4, respectively. Each chamber 618-1 . . . 618-4 may lead to a separate nanochannel array apparatus for experimentation. For example, molecules may be selected for optical length measurements, amplification of a specific fragment by PCR, selection of a fragment for sequencing, partitioning of DNA haplotypes, single-molecule sequencing, or other on chip analysis or processing known in the art. Embodiments shown in FIG. 6 demonstrate that individual molecules may be moved though a channel network in a serial way, and then enriched at one location, while contacting only the dielectric channel wall surface.

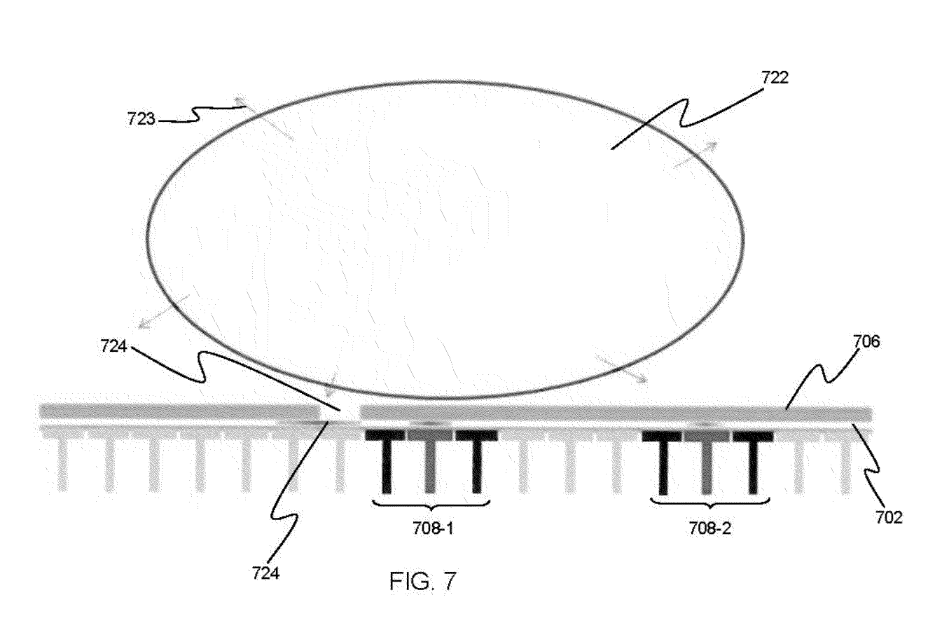

In one or more embodiments of the invention, the nanofluidic array apparatus may be combined with pressure-driven flow to isolate highly charged molecules (e.g., DNA, RNA) from lysed cells from other cellular components. In one or more embodiments of the invention, the nanofluidic array apparatus may be coupled to a microfluidic channel to enable discrete sampling of the microfluidic solution. FIG. 7 is a schematic of an operation of an apparatus in accordance with one or more embodiments of the invention. In FIG. 7, cell 722 at rest on the top of the ceiling 706. The cell 722 emits chemicals 724, for example metabolites, as indicated by the arrows 723. The chemicals 724 may diffuse into the cavity 702 through a hole 726 in the ceiling 706. The electrodes 708-1 near the hole may initially be floating, but when chemicals 724 have entered the cavity 702, a combination of positive and negative charges on the electrodes 708-1 may pinch off part of chemicals 724 then shuffle part of the chemicals 724 down the cavity 702 using the electrodes 708-2. The chemicals 724 may then be sorted, or moved to an analysis region. For example, an analysis region may include an LC or electrophoretic separation column, or an electrospray tip leading to a mass spectrometer. Embodiments of the invention may allow for snapshots of emitted chemicals from cells to be analyzed as a function of time. In addition, the device could be used inversely, to deliver molecules to specific cells located above the ceiling 706.

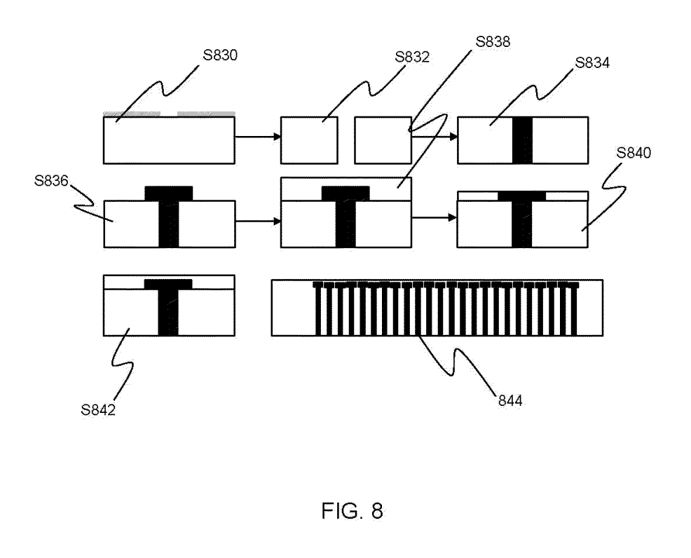

FIG. 8 is a schematic of a method of manufacturing an apparatus in accordance with one or more embodiments of the invention. In S830, a wafer is patterned according to known photolithography techniques. The pattern is determined by the desired locations of the vias and, thus, the sizes and locations of the resultant electrodes in the apparatus. In S832, a through hole is created using, for example, reactive ion etching to create a hole in the wafer. In S834, after the removal of the photoresist, the through hole is filled with a metal or other conducting material to form the vias illustrated in the previous figures. In S836, the metal or another conducting material is further grown (or deposited) according to known techniques to form the electrodes illustrated in the previous figures. In S838, the electrode and wafer surface may be covered with dielectric material to fill in the gaps between adjacent electrodes. Then, in S840, the surface may be optionally planarized using, for example, chemical mechanical planarization (CMP) techniques. Following planarization, in S842, the thin dielectric layer, as illustrated in the previous figures, may be optionally deposited according to known techniques. The resulting component 844 is an array of independently addressable electrodes with vias for electrical contact on the backside of the device substrate.

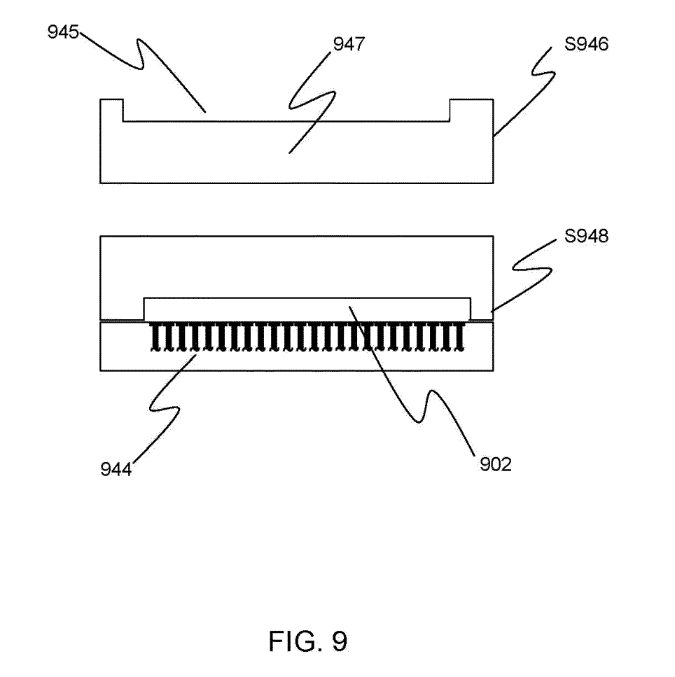

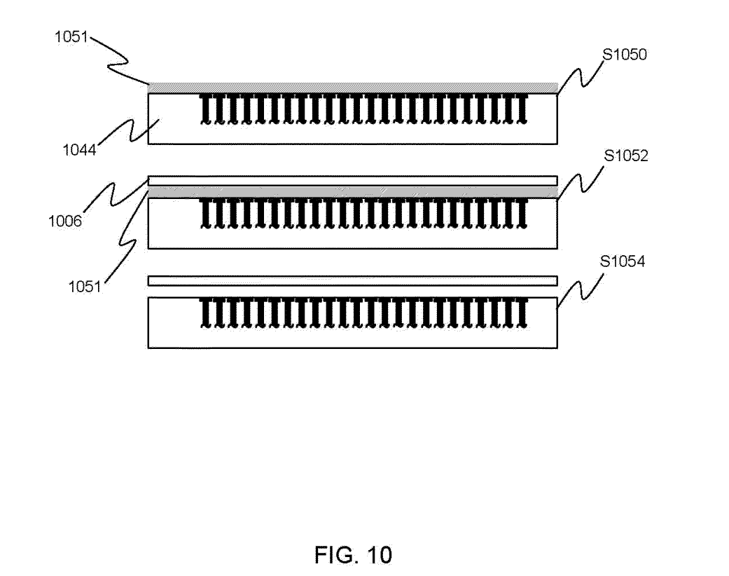

FIGS. 9 and 10 are alternative methods for interfacing the component 844 with a cavity in accordance with one or more embodiments of the invention. Referring to FIG. 9, in S946, a trench 945 with nanoscale depth is created in a second wafer 947 according to known microfluidics and/or MEM fabrication techniques, such as photolithography or a dry etch. Then, in S948, the second wafer 947 is bonded with component 944 such that the trench 945 forms the cavity 902. Care should be taken when bonding the second wafer 947 to the component 944 to produce a uniform depth of the cavity 902. However, small deviations or imperfections in the manufacturing processes disclosed herein may be compensated for by the magnitude of the applied voltages to the electrodes and/or the ionic strength of the solution used.

FIG. 10 is an alternative method of manufacturing one or more of the embodiments of the invention. In S1050, a thin sacrificial layer 1051 is deposited on the electrode side of the component 1044. The thickness of the sacrificial layer 1051 determines the depth the cavity. Then, in S1052, a dielectric or insulating layer 1006 is deposited on the thin sacrificial layer 1051. The sacrificial layer 1051 and the dielectric or insulating layer 1006 may be deposited according to known techniques, for example, chemical vapor deposition (CVD), low pressure chemical vapor deposition (LPCVD), sputtering, and/or atomic layer deposition (ALD). In S1054, a wet or dry etch may be used to selective remove the sacrificial layer 1051. As is known in the art, S1054 may include the providing an etch hole prior to removal of the sacrificial layer 1051, and subsequently capping such an etch hole.

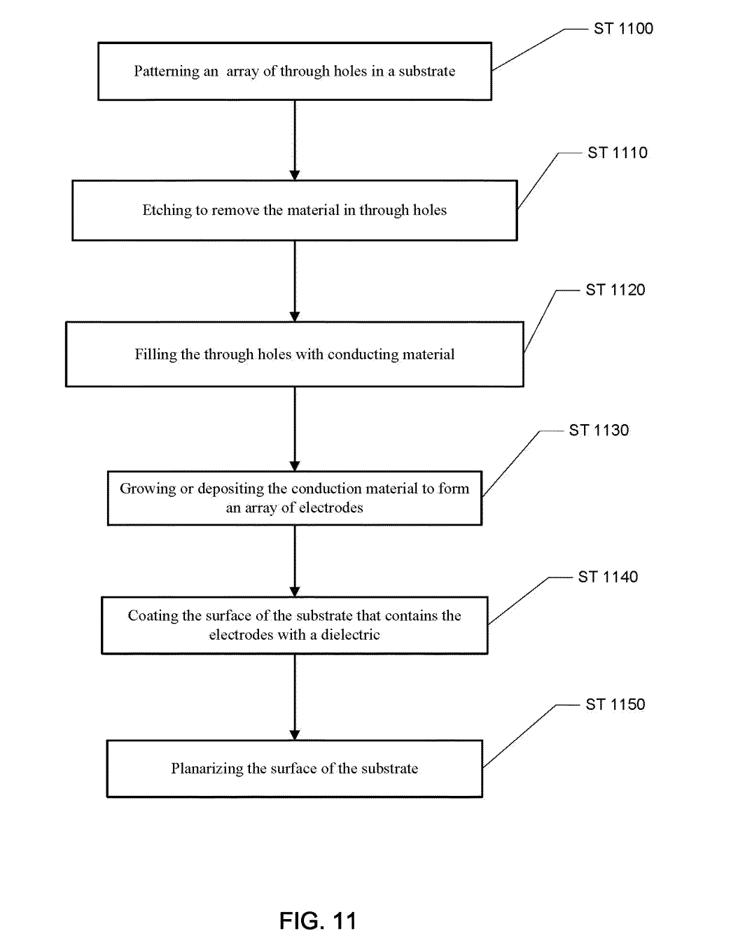

FIG. 11 is a flowchart summarizing a method in accordance with one or more embodiments of the invention. In ST 1100, an array of through holes is patterned on a substrate using, for example, photolithography. In ST 1110, the substrate is etched to remove the material in the through holes. In ST 1120, the through holes are filled with a conducting material, for example, a metal. In ST 1130, conducting material is further deposited, or grown, to form an array of electrodes. The conducting material used to form the electrodes may, or may not, be the same conducting material used to fill the through holes. In ST 1140, the surface of the substrate including the electrodes is coated with a dielectric. In ST 1150, the surface of the substrate including the electrodes is planarized.

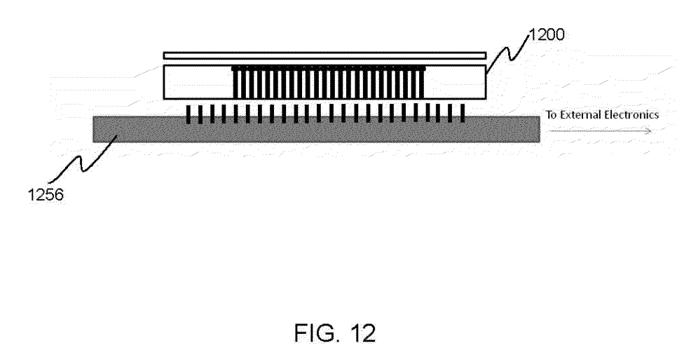

As described previously, embodiments of the claimed invention may include independently addressable electrodes through electrical contact to the vias on the backside of the apparatus. The vias may be connected to external electronics through a circuit board. In other words, the external electronics referred to herein may include additional circuit boards or components to facilitate connections to the vias. FIG. 12 is a schematic of an apparatus 1200 connected to a circuit board 1256 to facilitate the connection of the external electronics to the vias. The circuit board 1256 may be manufactured according to known techniques to contact each of the vias in the apparatus 1200. The vias may be connected, for example, through wire bonding to contact pads or interfacing with a printed circuit board presenting an array of pins. As is known in the art, there are numerous methods for connecting and aligning the apparatus 1200 to allow each via in the apparatus 1200 to be independently addressable.

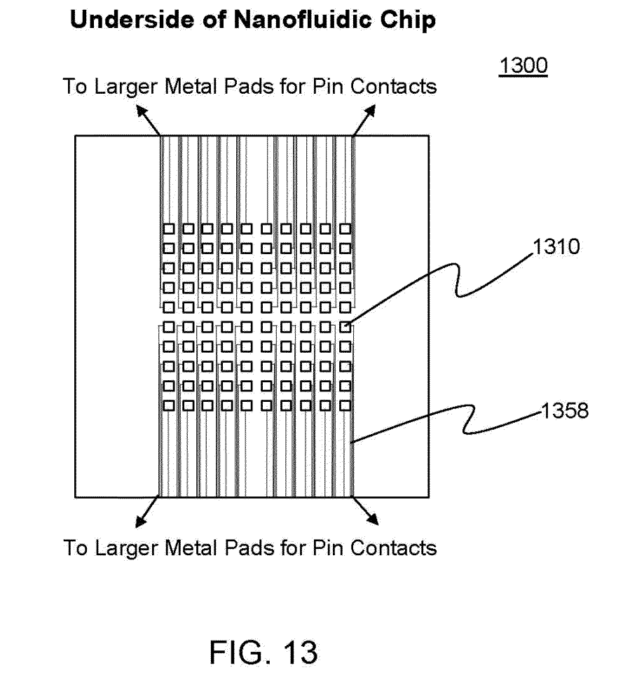

In one or more embodiments of the invention, as shown in FIG. 13, electrical contacts 1358 may be deposited on the back side of an apparatus 1300 such that each contact 1358 is connected to an individual via. The contacts 1358 may be patterned to facilitate the electrical connection of the apparatus 1300 to a circuit board, pin contacts, or other means for the application of voltages by the external electronics.

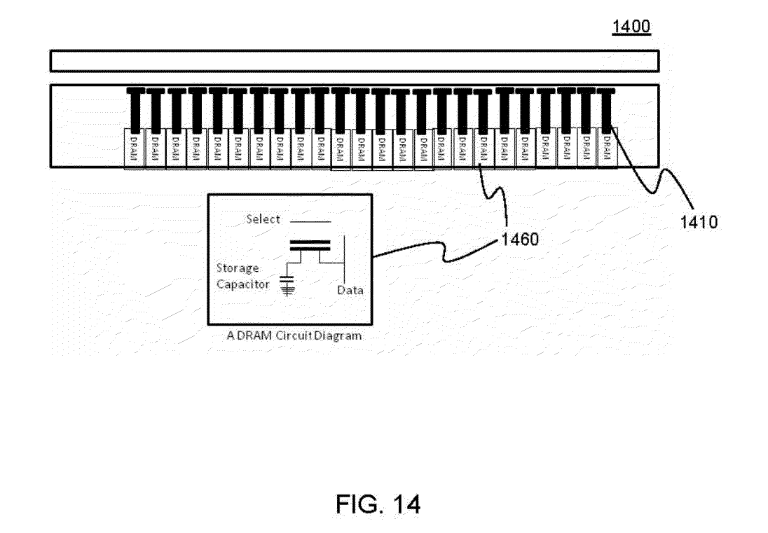

In addition, further components may be incorporated in the apparatus in accordance with one or more embodiments of the invention. For example, FIG. 14 shows the incorporation of a DRAM circuit 1460 connected to each via 1410. The DRAM circuit 1460 may be incorporated into the apparatus 1400 according to known techniques. The DRAM circuits 1460 may provide for an on chip demultiplexing strategy, similar to known DRAM or CMOS image sensor designs.

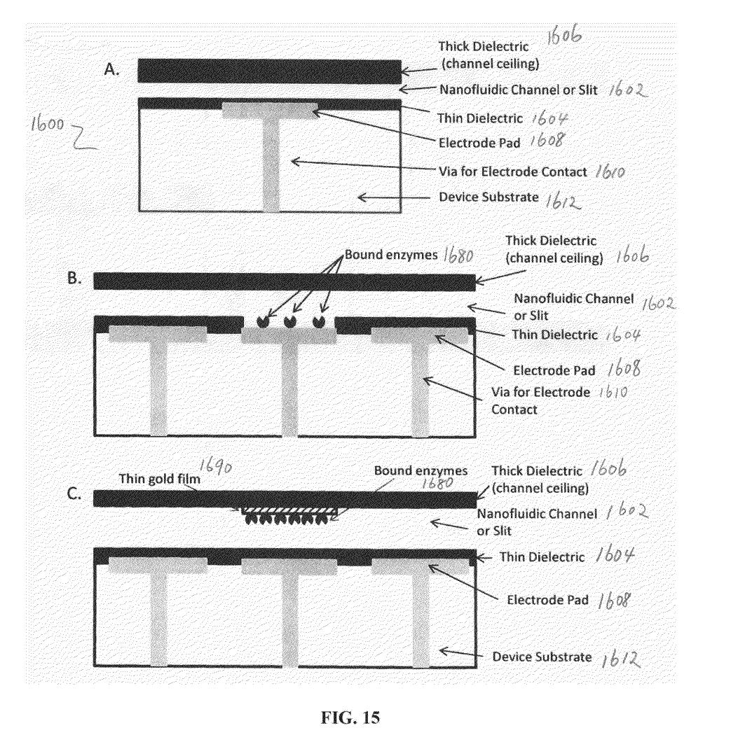

In certain embodiments of the invention, certain regions of the nanofluidic array are coated with gold, to which proteins with free cysteine residues can bind via a gold-thiolate bond. (Ulman, et al. 2011 J Nanobiotech. 9:26 “Highly active engineered-enzyme oriented monolayers: formation, characterization and sensing applications”.) FIG. 15B shows a schematic illustration of an electrode element in the nanofludic CCD array, wherein one of the electrodes is not covered by the dielectric, and instead is a surface upon which enzymes may be bound (e.g., a gold surface). FIG. 15C depicts an alternative embodiment where the enzymes are bound to a gold file in the ceiling of the device.

The gold surface can be created in a specific region by etching the dielectric away to expose a gold electrode (FIG. 15B). Alternatively, a gold pattern can be created on the ceiling of the nanofluidic channel, if the nanofluidic channel is created via a sacrificial method, wherein the sacrificial material is removed from the channel and the gold pattern and dielectric layer remains.

In other embodiments, protein enzymes can bind to antibodies bound to the modified surface. If the dielectric layer over certain electrodes is removed (FIG. 15B), voltage can be applied to that electrode to perform electrochemistry on the electrode surface, which can be used either to bind modified proteins or nucleic acids, or to create a coating on the electrode.

Devices and methods of the invention can be adopted in a microfluidic or nanofluidic device together with other functions, such as a nanofluidic “bump array” for fluid exchange, cell lysing, or particle sorting, or nanofluidic channels for polymer sizing. For example, a combined lab-on-chip device can be constructed which lyses individual bacterial cells, pass the genome of the cells to restriction digestion stations (this invention) and size the resulting fragments in nanofluidic channels. (Morton, et al. 2008 Lab Chip. 9:1448-53. “Crossing microfluidic streamlines to lyse, label and wash cells”, E. pub. 2008, Jul. 23); Mannion, et al. 2007 Biopolymers 85(2): 131-43, “Nanofluidic structures for single biomolecule fluorescent detection”).

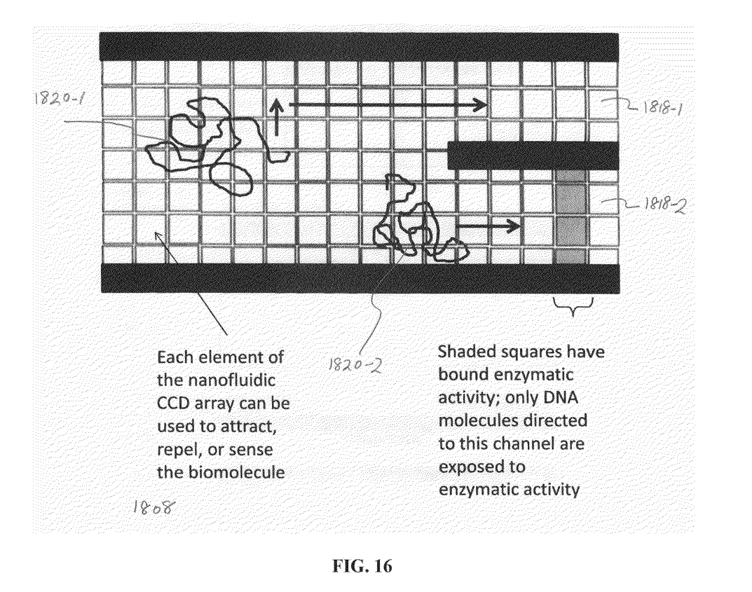

FIG. 16 schematically illustrates a two-dimensional nanofluidic CCD arrays that has specific areas for bound enzymatic activities. In FIG. 16A, a top view of electrode pads (grey) is shown with modified attachment squares (black). FIG. 16B shows a top view of electrode pads (grey) and modified attachment squares in a nanofluidic slit (a 3-dimensional view).

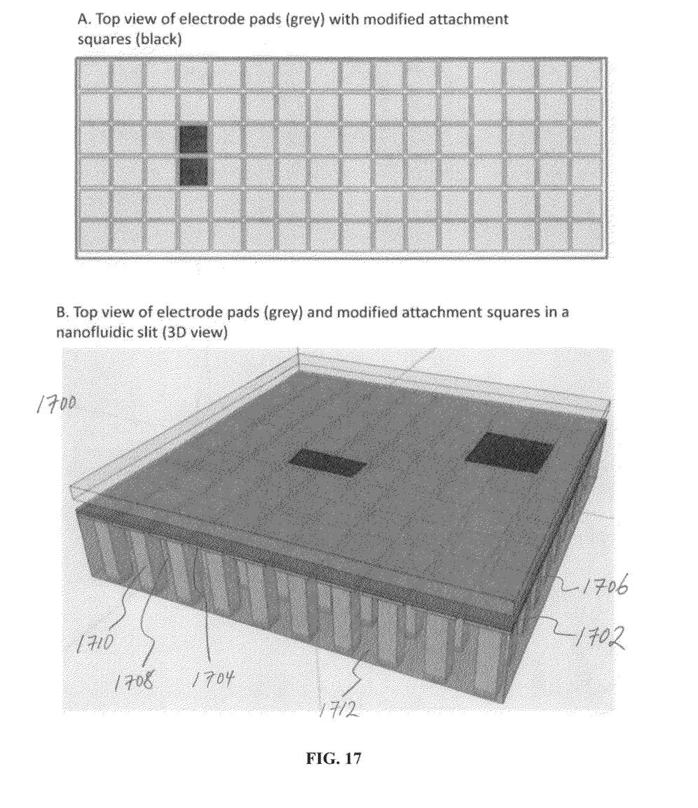

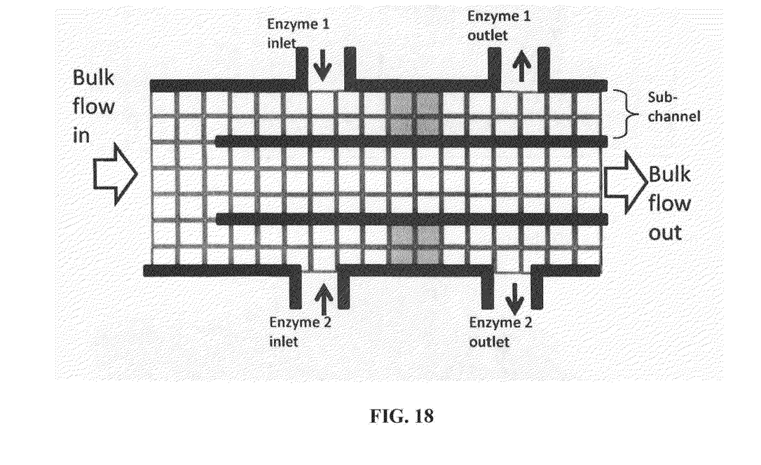

FIG. 17 schematically illustrates a top view of DNA molecules moving in nanofluidic CCD array. In FIG. 18, a nanofluidic CCD array is shown in a top view and with more than one enzymatic activity bound in different regions. A device may be constructed with side “enzyme loading channels” that address only one sub-channel. Thus one device can be constructed with one method of attachment (e.g., patterned gold in different sub-channels), but different enzymatic activities can be bound in separate regions of the device. By controlling the pressure of all inlets and outlets, the flow of enzymes can be controlled such that a given enzyme only flows through one region of the device, and thus only binds to one modified region. Such a device can be used to perform digestion of long DNAs with restriction enzymes. Certain DNA molecules can be selected for digestion with one enzyme, while other DNA molecules are left undigested (FIG. 17) or digested with a different enzyme (FIG. 18).

In certain embodiments, a polymerase may be bound to the surface of the chip to incorporate labeled nucleotides at breaks or nicks in the DNA. In other embodiments, antibodies to DNA modifications such as methylation can be used, to retain methylated DNAs in one region of the device. Alternatively, DNA aptamers can provide the enzymatic activity, either as bound entitites or as nucleic acids localized to an electrode via the nanofluidic CCD array technology. For example, devices of the invention provides a nanofluidic device that has enzymatic activities bound to certain regions the molecule sensing and actuation ability provided by the nanofluidic CCD array.

In one aspect, the invention generally relates to an apparatus for manipulation of a molecule or group of molecules in a solution. The apparatus includes: (1) a nanofluidic cavity, a bottom of which is made of a dielectric layer, wherein the depth of the nanofluidic cavity is on the order of or less than the ionic screening length of the solution filling the nanofluidic cavity; (2) a plurality of electrodes arranged on a surface of the dielectric layer opposite a surface of the dielectric layer having the nanofluidic cavity, wherein a spacing between individual electrodes in the array of electrodes is not significantly greater than the ionic screening length of the solution filling the nanofluidic cavity; and (3) a plurality of vias individually connected to the individual electrodes for connection to an external electronic device.

In certain embodiments of the invention, the array of the electrodes is a two dimensional array. In certain preferred embodiments, one or more electrodes in the array of electrodes are independently addressable, through the array of vias, by the external electronic device. The electric potential applied to the one or more electrodes is chosen such that negligible electric current flows between the electrode and the solution in the cavity.

In certain preferred embodiments, the dielectric layer is of sufficient thickness, quality, and material composition to limit electron transfer during operation while also allowing for strong electrostatic coupling between the gate electrode and molecules in the fluidic cavity. For example, the depth of the nanofluidic cavity may be greater than about 1 nm and less than about 1,000 nanometers (e.g., from about 1 nm to about 900 nm, from about 1 nm to about 800 nm, from about 1 nm to about 700 nm, from about 1 nm to about 600 nm, from about 1 nm to about 500 nm, from about 1 nm to about 400 nm, from about 1 nm to about 300 nm, from about 1 nm to about 200 nm, from about 1 nm to about 100 nm, from about 100 nm to about 1,000 nm, from about 100 nm to about 1,000 nm, from about 100 nm to about 1,000 nm, from about 100 nm to about 900 nm, from about 100 nm to about 800 nm, from about 100 nm to about 700 nm, from about 100 nm to about 600 nm, from about 100 nm to about 500 nm, from about 100 nm to about 500 nm, from about 100 nm to about 400 nm, from about 100 nm to about 300 nm, from about 100 nm to about 200 nm). In some preferred embodiments, the depth of the nanofluidic cavity is less than approximately 150 nanometers and greater than approximately 1 nm.

In certain embodiments, the apparatus further includes a hole in the ceiling to enable diffusion of the molecule through the hole into the fluid-filled cavity.

In certain embodiments, the apparatus further includes a second array of electrodes disposed on a top surface of the dielectric layer of the ceiling; and a second array of vias individually connected to the individual electrodes in the second array of electrodes for connecting the second array of electrodes to the external electronic device. The one or more electrodes of the second array of electrode are independently addressable, through the second array of vias, by the external electronic device.

In certain embodiments, the external electronic device includes integrated on chip electronics.

In certain embodiments, the apparatus further includes one or more physical barriers partitioning the nanofluidic cavity into two or more passages or compartments. In some embodiments, at least one of the passages or compartments allows therein a physical or biochemical manipulation of the one or more analyte molecules or particles in the sample, without affecting molecules in the other passages or compartments. In some embodiments, one or more of the passages or compartments is connected to fluidic channels allowing fluid exchange between said passages or compartments, without exchanging fluid in the entire cavity. In some embodiments, a portion of the cavity is modified to expose selected molecules to biochemical or physical modification. In some embodiments, the modification of the cavity comprises immobilization of one or more protein or DNA molecules at a specific region of the cavity.

In certain embodiments, the thickness of the dielectric layer is less than about 30 nanometers (e.g., less than about 25 nm, less than about 20 nm, less than about 15 nm, less than about 10 nm, less than about 5 nm). In some preferred embodiments the thickness of the dielectric layer is less than approximately 15 nanometers.

In certain embodiments, the biochemical manipulation is selected from an oxidation-reduction reaction, an enzymatic reaction, a nuclease digestion, a fluorescent labeling reaction, affinity-based binding, a phosphorylation or dephosphorylation reaction, or covalent modification.

In certain embodiments, the biochemical manipulation is selected from an oxidation-reduction reaction, an enzymatic reaction, a nuclease digestion, a fluorescent labeling reaction, affinity-based binding, a phosphorylation or dephosphorylation reaction, or covalent modification.

In another aspect, the invention generally relates to an apparatus for manipulation of a molecule or group of molecules in a solution. The apparatus includes: (1) a nanofluidic cavity, wherein a depth of the nanofluidic cavity is on the order of or less than the ionic screening length of the solution filling the nanofluidic cavity; (2) an array of electrodes arranged on a surface the nanofluidic cavity, wherein a spacing between individual electrodes in the array of electrodes is not significantly greater than the ionic screening length of the solution filling the nanofluidic cavity; and (3) an array of vias individually connected to the individual electrodes in the array of electrodes for connecting the array of electrodes to an external electronic device. An applied voltage applied to the individual electrodes in the array is less than an overpotential required to transfer an electron from the metal electrode to any chemical species in solution.

In yet another aspect, the invention generally relates to an apparatus for manipulating one or more analyte molecules or nanoparticles in a solution. The apparatus includes: a nanofluidic cavity defined by a dielectric ceiling and a floor substrate, having a depth from about 10 nm to about 1,000 nm; a plurality of electrodes disposed on a surface of the floor substrate opposite a surface of the dielectric ceiling defining the nanofluidic cavity; and a plurality of vias, each being individually connected to an electrode of the plurality of electrodes for connection to an external electronic device. The apparatus may further include one or more barriers or gates partitioning the nanofluidic cavity into two or more passages or compartments, wherein each of the passages or compartments may be designed to allow therein a physical or biochemical manipulation of the one or more analyte molecules or particles in the sample. The apparatus may additionally include one or more apertures in the dielectric ceiling allowing diffusion into and/or out of the nanofluidic cavity.

In yet another aspect, the invention generally relates to a method for manipulating of one or more analyte molecules or particles. The method includes: providing a nanofluidic cavity, defined by a dielectric ceiling and a floor substrate, having a depth from about 10 nm to about 1,000 nm; providing a plurality of electrodes disposed on a surface of the floor substrate opposite a surface of the dielectric ceiling defining the nanofluidic cavity; providing a plurality of vias, each being individually connected to an electrode in the plurality of electrodes, whereby each electrode is connected to and individually addressable by an external electronic control unit; depositing inside the nanofluidic cavity a solution having the one or more analyte molecules or particles to be manipulated; and asserting one or more electrical voltages or signals to one or more of the electrodes in the plurality of electrodes to induce a spatial movement of the one or more analyte molecules or particles in the sample inside the nanofluidic cavity.

Specific embodiments of the invention will now be described in detail with reference to the accompanying figures. Like elements in the various figures are denoted by like reference numerals for consistency. Further, the use of “Fig.” in the drawings is equivalent to the use of the term “Figure” in the description.

In this specification and the appended claims, the singular forms “a,” “an,” and “the” include plural reference, unless the context clearly dictates otherwise.

Unless defined otherwise, all technical and scientific terms used herein have the same meaning as commonly understood by one of ordinary skill in the art. Although any methods and materials similar or equivalent to those described herein can also be used in the practice or testing of the present disclosure, the preferred methods and materials are now described. Methods recited herein may be carried out in any order that is logically possible, in addition to a particular order disclosed.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### INCORPORATION BY REFERENCE

References and citations to other documents, such as patents, patent applications, patent publications, journals, books, papers, web contents, have been made in this disclosure. All such documents are hereby incorporated herein by reference in their entirety for all purposes. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

### EQUIVALENTS

The representative examples disclosed herein are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples which follow and the references to the scientific and patent literature cited herein. The following examples contain important additional information, exemplification and guidance that can be adapted to the practice of this invention in its various embodiments and equivalents thereof.

What is claimed is:

1. An apparatus for manipulation of a molecule or group of molecules in a solution, comprising:
a nanofluidic cavity, a bottom of which is made of a dielectric layer, wherein the depth of the nanofluidic cavity is on the order of or less than the ionic screening length of the solution filling the nanofluidic cavity;
a plurality of electrodes arranged on a surface of the dielectric layer opposite a surface of the dielectric layer having the nanofluidic cavity, wherein a spacing between individual electrodes in the array of electrodes is not significantly greater than the ionic screening length of the solution filling the nanofluidic cavity; and
a plurality of vias individually connected to the individual electrodes for connection to an external electronic device.

2. The apparatus of claim 1, wherein the array of the electrodes is a two dimensional array.

3. The apparatus of claim 1, wherein one or more electrodes in the array of electrodes are independently addressable, through the array of vias, by the external electronic device.

4. The apparatus of claim 1, wherein the electric potential applied to one or more electrodes is chosen such that negligible electric current flows between the electrode and the solution in the cavity.

5. The apparatus of claim 1, wherein the dielectric layer is of sufficient thickness, quality, and material composition to limit electron transfer during operation while also allowing for strong electrostatic coupling between the gate electrode and molecules in the fluidic cavity.

6. The apparatus of claim 1, wherein the depth of the nanofluidic cavity is less than approximately 1000 nanometers and greater than approximately 1 nm.

7. The apparatus of claim 1, wherein the depth of the nanofluidic cavity is less than approximately 150 nanometers and greater than approximately 1 nm.

8. The apparatus of claim 1, further comprising:
a hole in the ceiling to enable diffusion of the molecule through the hole into the fluid-filled cavity.

9. The apparatus of claim 1, further comprising:
a second array of electrodes disposed on a top surface of the dielectric layer of the ceiling; and
a second array of vias individually connected to the individual electrodes in the second array of electrodes for connecting the second array of electrodes to the external electronic device.

10. The apparatus of claim 9, wherein one or more electrodes of the second array of electrode are independently addressable, through the second array of vias, by the external electronic device.

11. The apparatus of claim 1, wherein the external electronic device includes integrated on chip electronics.

12. The apparatus of claim 1, further comprising one or more physical barriers partitioning the nanofluidic cavity into two or more passages or compartments.

13. The apparatus of claim 12, wherein at least one of the passages or compartments allows therein a physical or biochemical manipulation of the one or more analyte molecules or particles in the sample, without affecting molecules in the other passages or compartments.

14. The apparatus of claim 12, wherein one or more of the passages or compartments is connected to fluidic channels allowing fluid exchange between said passages or compartments, without exchanging fluid in the entire cavity.

15. The apparatus of claim 1, wherein a portion of the cavity is modified to expose selected molecules to biochemical or physical modification.

16. The apparatus of claim 15, wherein the biochemical manipulation is selected from an oxidation-reduction reaction, an enzymatic reaction, a nuclease digestion, a fluorescent labeling reaction, affinity-based binding, a phosphorylation or dephosphorylation reaction, or covalent modification.

17. The apparatus of claim 16, wherein the modification of the cavity comprises immobilization of one or more protein or DNA molecules at a specific region of the cavity.

18. The apparatus of claim 13, wherein the biochemical manipulation is selected from an oxidation-reduction reaction, an enzymatic reaction, a nuclease digestion, a fluorescent labeling reaction, affinity-based binding, a phosphorylation or dephosphorylation reaction, or covalent modification.

19. The apparatus of claim 1, wherein the thickness of the dielectric layer is less than approximately 30 nanometers.

20. The apparatus of claim 1, wherein the thickness of the dielectric layer is less than approximately 15 nanometers.

21. An apparatus for manipulation of a molecule or group of molecules in a solution, comprising:
a nanofluidic cavity, wherein a depth of the nanofluidic cavity is on the order of or less than the ionic screening length of the solution filling the nanofluidic cavity;
an array of electrodes arranged on a surface the nanofluidic cavity, wherein a spacing between individual electrodes in the array of electrodes is not significantly greater than the ionic screening length of the solution filling the nanofluidic cavity; and
an array of vias individually connected to the individual electrodes in the array of electrodes for connecting the array of electrodes to an external electronic device, wherein an applied voltage applied to the individual electrodes in the array is less than an overpotential required to transfer an electron from the metal electrode to any chemical species in solution.
